(19) United States
(12) Patent Application Publication
(10) Pub. No.: US 2014/0045069 A1
(43) Pub. Date: Feb. 13, 2014

(54) LITHIUM SECONDARY CELL

(71) Applicants: Tatsuji Numata, Tokyo (JP); Tetsuya Kajita, Tokyo (JP); Hiroo Takahashi, Tokyo (JP); Daisuke Kawasaki, Tokyo (JP)

(72) Inventors: Tatsuji Numata, Tokyo (JP); Tetsuya Kajita, Tokyo (JP); Hiroo Takahashi, Tokyo (JP); Daisuke Kawasaki, Tokyo (JP)

(21) Appl. No.: 14/112,973

(22) PCT Filed: Apr. 27, 2012
(86) PCT No.: PCT/JP2012/061400

§ 371 Date: Oct. 21, 2013

(30) Foreign Application Priority Data
Apr. 28, 2011 (JP) 2011-101509

(51) Int. Cl. H01M 4/36

(52) U.S. Cl. CPC H01M 4/364
USPC 429/221; 252/182.1; 429/224

(57) ABSTRACT

Provided is a lithium secondary cell in which elution of manganese from a manganese olivine compound into an electrolyte is suppressed, a high level of safety is obtained, the charge/discharge cycle efficiency and suppression of leakage of manganese during storage can be maintained over a long period, a long lifespan is obtained, a rapid decrease in cell voltage near the end of discharge is suppressed, and output characteristics are enhanced, when a manganese olivine compound having excellent stability during charge/discharge is used as the principal component in the positive electrode active material. The positive electrode contains a positive electrode active material containing an olivine compound represented by LiMm₁₋ₐXₐPO₄ (where X represents Mg and/or Fe, and a represents a value that satisfies 0≦a≦0.3) and a lithium nickel oxide represented by LiNi_{1-b}Z_{b}O₂ (where Z represents one or more selected from Co, Mn, Al, Mg, and V; and b represents a value that satisfies 0≦b≦0.4), the content of the olivine compound being from 50 to 95 mass %.

### TECHNICAL FIELD

The present invention relates to an extended-life lithium secondary cell having reduced deterioration in repetitive charge/discharge, superior cycle properties, high safety and improved energy density.

### BACKGROUND

A lithium secondary cell which uses an organic solvent, absorbs and releases reversibly lithium ions on positive and negative electrodes and allows repetitive charge/discharge has been extensively used in applications such as potable electronic devices or personal computers, and even in a battery for driving a motor in hybrid electric vehicles or bikes, and is being focused on its development. There are needs for advanced miniaturization and weight lightening in such a lithium secondary cell, as well as increased amounts of lithium ions absorbed and released reversibly in positive and negative electrodes, more increased capacity, reduced cycle deterioration during charge/discharge, and improved safety.

To meet these needs, olivine compounds are focused on as a positive electrode active material for a lithium secondary cell since these compounds exhibit suppressed deterioration in repetitive charge/discharge, allow stable charge/discharge and have excellent cycle properties.

Positive electrodes using lithium iron phosphate (it is referred to as an iron olivine compound) among such olivine compounds have been commercialized. Lithium manganese phosphate (it is referred to as a manganese olivine compound) having operation voltage higher than that of iron olivine compounds is expected to have a high level of energy density. Thus, for a negative electrode having high operation voltage, manganese olivine compounds are particularly suitable for a positive electrode active material since they suppress a decrease in cell voltage and energy density. However, such manganese olivine compounds have a problem that manganese is eluted into an electrolytic solution. Further, there are problems that conductivity is low, resistance is rapidly increased and output is lowered around the end of discharge, i.e., in low SOC (state of charge) area, as well as charge/discharge cycle properties are deteriorated, and cell life is shortened. Various attempts have been made to realize an acceptable positive electrode using the manganese olivine compound.

Specifically, as a positive electrode using manganese olivine compounds, it has been reported a positive electrode in which a contact between lithium nickel oxide and an electrolytic solution and hence reactions are suppressed to obtain high temperature stability by using a positive electrode active material comprising lithium nickel oxide particles of which surfaces are coated with an olivine compound (Patent Document 1); a positive electrode having improved charge/discharge capacity density and thermal stability by using a positive electrode active material in which lithium olivine oxide of less than 5 wt % with respect to lithium nickel oxide is mixed such that the olivine compounds are partially contacted with the surfaces of lithium nickel oxide (Patent Document 2); and a positive electrode having high capacity by using a positive electrode active material comprising at least one of lithium cobalt oxide and lithium nickel oxide and at least one of a manganate spinel and an olivine compound (Patent Document 3).

As other examples using iron olivine compounds as a positive electrode active material, the following secondary cells have been reported: a lithium secondary cell in which the flare generation due to overcharge is suppressed by using a positive electrode including at least one transition metal compounds selected from lithium-containing nickel and cobalt and an olivine compound (Patent Document 4); a cell of improved safety having a positive electrode including an oxide comprising lithium and at least one selected from iron, manganese and cobalt and a phosphorus oxide having olivine type crystal structure and a negative electrode including a carbon material in which the negative electrode has capacity that capacity by absorption and release of lithium and capacity by precipitation and dissolution of lithium are summed (Patent Document 5); a secondary cell in which output regeneration is excellent and cell resistance increase in high temperature storage is suppressed by using a positive electrode active material comprising lithium-containing olivine type phosphate and lithium-containing transition metal oxide comprising Ni and Mn (Patent Document 6); and a secondary cell in which the remaining capacity of a cell may be easily detected by using a positive electrode active material comprising lithium-containing transition metal composite oxide having olivine crystal structure and lithium-containing transition metal composite oxide (Patent Document 7).

However, in the foregoing conventional secondary cells, olivine compounds are present at a small amount, and accessorily used. None of these secondary cells comprises the olivine compound as the principal component in the positive electrode active material. Therefore, these conventional secondary cells do not exhibit high operation voltage, safe and stable charge/discharge and high energy density, which are advantages of manganese olivine compounds.

For a negative electrode used together with a positive electrode using the manganese olivine compound, if silicon is used as an active material having lithium absorption and release amount 3 times greater than that of graphite commonly used, it may be expected to obtain increased cell capacity. However, in a cell using silicon as a negative active material, output reduction around the end of discharge is greatly increased as compared with a negative electrode using graphite. In view of acceptable cell life and output reduction, an excessive amount of manganese olivine compound is required, and it is not practical.

There is a need for an extended-life lithium secondary cell in which a decrease in cell voltage for a negative electrode having high operation voltage, a decrease in energy, the elution of manganese from a manganese olivine compound into an electrolytic solution, and an output reduction in low SOC area due to rapid resistance increase may be suppressed; as well as acceptably high energy density and high safety during charge/discharge may be obtained, when a manganese olivine compound is used as the principal component in a positive electrode active material.

Patent Document 1: JP Patent Application Publication No. 2004-87299

Patent Document 2: JP Patent Application Publication No. 2007-335245

Patent Document 3: JP Patent Application Publication No. 2008-525973

Patent Document 4: JP Patent Application Publication No. 2005-183384

Patent Document 5: JP Patent Application Publication No. 2002-279989

Patent Document 6: JP Patent Application Publication No. 2007-234565

Patent Document 7: JP Patent Application Publication No. 2007-250299

### SUMMARY OF THE INVENTION

An object of the present invention is to provide a lithium secondary cell in which elution of manganese from a manganese olivine compound into an electrolytic solution is suppressed, a high level of safety is obtained, the charge/discharge cycle efficiency and suppression of leakage during storage can be maintained over a long period, a long lifespan is obtained, a rapid decrease in cell voltage around the end of discharge is suppressed, and output characteristics are enhanced, a decrease in cell voltage is suppressed particularly even when a negative electrode active material having high operation voltage is combined, and a high level of energy density is obtained, when a manganese olivine compound having excellent stability during charge/discharge is used as the principal component in a positive electrode active material.

The inventors have intensively studied, and have found that when a manganese olivine compound as the principal component and a specific lithium nickel oxide are used as a positive electrode active material, the elusion of manganese from the manganese olivine compound into an electrolytic solution in storage and repetitive charge/discharge at high operation voltage may be avoided, and a rapid increase in resistance around the end of discharge may be suppressed. The inventors have completed the present invention based on these findings.

The present invention provides a lithium secondary cell in which a positive electrode includes a positive electrode active material comprising an olivine compound represented by formula (1):

LiMn₁₋ₐXₐPO₄ (1)

(where X represents Mg and/or Fe, and a represents a value that satisfies 0≦a≦0.3), and a lithium nickel oxide represented by formula (2):

LiNi_{1-b}Z_{b}O₂ (2)

(where Z represents one or more selected from Co, Mn, Al, Mg, and V; and b represents a value that satisfies 0≦b≦0.4), and the positive electrode active material contains 60 to 95 mass % of the olivine compound represented by the formula (1).

According to the present invention, provided is a lithium secondary cell in which elution of manganese from a manganese olivine compound into an electrolytic solution is suppressed, a high level of safety is obtained, the charge/discharge cycle efficiency and suppression of leakage of manganese during storage can be maintained over a long period, a long lifespan is obtained, a rapid decrease in cell voltage around the end of discharge is suppressed, and output characteristics are enhanced, a decrease in cell voltage is suppressed particularly even when a negative electrode active material having high operation voltage is combined, and a high level of energy density is obtained, when a manganese olivine compound having excellent stability during charge/discharge is used as the principal component in a positive electrode active material.

### BRIEF DESCRIPTION OF THE DRAWINGS

FIG. 1 shows a schematic diagram illustrating a structure of an example of a lithium secondary cell according to the present invention.

1 Negative electrode active material layer

2 Positive electrode active material layer

3 Negative electrode current collector

4 Positive electrode current collector

5 Separator

6, 7 Laminate film outer body

8 Positive lead tab

9 Negative lead tab

### DESCRIPTION OF THE INVENTION

The lithium secondary cell according to the present invention has a positive electrode, a negative electrode and an electrolytic solution in which the positive electrode and the negative electrode are immersed.

### Positive Electrode

The positive electrode includes a positive electrode active material comprising an olivine compound represented by formula (1):

LiMm₁₋ₐXₐPO₄ (1)

(where X represents Mg and/or Fe, and a represents a value that satisfies 0≦a≦0.3) and a lithium nickel oxide represented by formula (2):

LiNi_{1-b}Z_{b}O₂ (2)

(where Z represents one or more selected from Co, Mn, Al, Mg, and V; and b represents a value that satisfies 0≦b≦0.4), and the positive electrode material contains 60 to 95 mass % of the olivine compound represented by the formula (1).

The olivine compound represented by the formula (1) (it is also referred to as manganese olivine compound (1)) comprised in the positive electrode active material is the principal component of the positive electrode active material, comprises Mn atom, and absorbs and releases reversibly during charge/discharge. For the manganese olivine compound (1), phosphorous atom and oxygen are strongly bonded and oxygen atom is released at a small amount during repetitive absorption and release of lithium ions involved in the charge/discharge of a cell. Therefore, stable cycle properties are obtained.

In the formula (1), X denotes Mg or Fe, replaces Mn, and may be either one of Mg or Fe, or those containing both of Mg or Fe. A substituting amount is preferably not more than 0.3 moles and greater than 0 mole, and more preferably between 0.1 and 0.3 moles. Additionally, in the formula (1), some of oxygen atoms may be substituted with fluorine atom or chlorine atom.

A content of the manganese olivine compound (1) present in the positive electrode active material is between 60 mass % and 95 mass %. If the content of the manganese olivine compound (1) is at least 60 mass %, a cell having high safety and high operation voltage is obtained. If the content is not more than 95 mass %, the elusion of Mn from the manganese olivine compound (1) into an electrolytic solution is suppressed, and also an output reduction in low SOC area is suppressed. Preferably, the content of the manganese olivine compound (1) is between 75 and 95 mass %, and more preferably between 80 and 90 mass %.

Also, the lithium nickel oxide represented by the formula (2) (it is also referred to as lithium nickel oxide (2)) is used as the positive electrode active material together with the manganese olivine compound (1). The lithium nickel oxide (2) absorbs and releases reversibly lithium ions during charge/discharge, suppresses the elusion of Mn from the manganese olivine compound (1) into an electrolytic solution during charge/discharge and storage, and suppresses a rapid increase in resistance of a negative electrode around the end of discharge.

In the formula (2), Z represents one or more selected from Co, Mn, Al, Mg and V, and replaces Ni. Among others, that containing Co is preferred, and further that containing Al is preferred. A substituting amount is preferably between 0.4 to 0.2 moles. Additionally, in the formula (2), some of oxygen atoms may be substituted with fluorine atom or chlorine atom.

A content of the lithium nickel oxide (2) present in the positive electrode active material is between 5 mass % and 40 mass %. If the content of the lithium nickel oxide (2) is not less than 5 mass %, the disengagement of Mn from the manganese olivine compound (1) during charge/discharge may be suppressed. If the content is not more than 40 mass %, a decrease in charge/discharge efficiency and a leakage of manganese during storage may be suppressed, and charge/discharge may be safely performed. The content of the lithium nickel oxide (2) present in the positive electrode active material is more preferably between 5 and 25 mass %, and even more preferably between 10 and 20 mass %.

The positive electrode active material may further comprise other positive electrode active materials as long as they do not adversely affect the function of the manganese olivine compound (1) and the lithium nickel oxide (2). Examples of other positive electrode active materials may include LiM1ₓMn₂₋ₓO₄ (M1: elements other than Mn, 0<x<0.4), LiCoO₂, Li(M2ₓMn₁₋ₓ)O₂ (M2: elements other than Mn and Ni), Li₂MSiO₄(M: at least one of Mn, Fe, Co), or the like. They may be used alone or as any combination of two or more species.

As for the manganese olivine compound (1) and the lithium nickel oxide (2), a specific surface area thereof may be for example 0.1-5 m²/g, preferably 0.2-4 m²/g, and more preferably 0.5-2 m²/g. If the specific surface area is not less than 0.1 m²/g, surface area in contact with an electrolytic solution may be controlled in a proper range, lithium ions may be readily moved in a positive electrode active material layer during charge/discharge, and more reduced resistance may be obtained. If the specific surface area is not more than 5 m²/g, the degradation of the electrolytic solution and the elusion of active material components into the electrolytic solution may be suppressed.

The specific surface area may be measured using a gas adsorption type specific surface area-measuring device.

As for the manganese olivine compound (1) and the lithium nickel oxide (2), an average of median particle size thereof is preferably 1-40 nm and more preferably 4-20 nm. If the average of median particle size of the manganese olivine compound (1) and the lithium nickel oxide (2) are not less than 1 μm, the elution of component elements into the electrolytic solution and the degradation of the positive electrode due to contact with the electrolytic solution may be suppressed. If the average of median particle size of the manganese olivine compound (1) and the lithium nickel oxide (2) are not more than 40 nm, lithium ions are easily absorbed and released in the positive electrode during charge/discharge, and more reduced resistance may be obtained.

The average of median particle size of the manganese olivine compound (1) and lithium nickel oxide (2) may be measured using a laser diffraction/scattering particle size distribution-measuring device.

As for the positive electrode active material, an amount per unit area of the positive electrode is preferably in the range of 45-80 mg/cm². If the positive electrode active material amount is in said range, a rapid increase in resistance of the negative electrode may be avoided, an increase in thickness of the positive electrode may be suppressed, a resistance increase in thickness direction may be suppressed, and an even contact with electrolytic solution may be achieved. Additionally, the amount may be readily adjusted relative to an amount of a negative electrode active material as described below, and the positive electrode active material layer comprising the positive electrode active material may be easily prepared.

The positive electrode active material may be used with an electro-conductive additive.

The electro-conductive additive decreases the impedance of the positive electrode active material. As such an electro-conductive additive, carbonaceous particulates such as graphite, carbon black or acetylene black, as well as metals capable of stably being under the operation voltage of charge/discharge may be used. A content of the electro-conductive additive may be 3-5 parts by weight with respect to 100 parts by weight of the positive electrode active material. If the electro-conductive additive is in said range, a decrease in the content of the positive electrode active material may be suppressed, and a high level of energy density and conductivity may be maintained.

The positive electrode active material and the electro-conductive additive may be formed integrally as a positive electrode active material layer adhered on a positive electrode current collector using a binder for the positive electrode.

Examples of binders include polyvinylidene fluoride (PVdF), vinylidene fluoride-hexa-fluoropropylene copolymer, vinylidene fluoride-tetrafluoroethylene copolymer, styrene-butadiene copolymer rubber, polytetrafluoroethylene, polypropylene, polyethylene, poly-imide, polyamideimide or the like. Among others, polyvinylidene fluoride is preferred in terms of generality and low cost. A content of the positive electrode binder used may preferably be 2-10 parts by weight with respect to 100 parts by weight of the positive electrode active material in terms of energy density and adhesion control.

Any current collector may be used as the positive electrode current collector as long as it has conductivity enough to allow a conductive connection with an outer terminal and supports the positive electrode active material layer comprising the positive electrode active material together with the binder. As a material for the positive electrode current collector, aluminum, SUS or the like are preferably used due to safety, and aluminum is more preferred. A shape of the positive electrode current collector may be any of foil, flat or mesh shape.

A thickness of the positive electrode current collector is preferably a thickness having strength enough to support the positive electrode active material layer. The thickness may be, for example 4-100 μm, and preferably 5-30 μm to increase energy density.

The positive electrode including the positive electrode active material may be prepared by providing a material for the positive electrode active material layer obtained from dispersing and mixing the positive electrode active material comprising powders of the manganese olivine compound (1) and the lithium nickel oxide (2), and as appropriate a powder of the electro-conductivity additive and the positive electrode binder in a solvent such as N-methyl-2-pyrrolidone, dry toluene or the like; coating the resulting material for the positive electrode active material layer on the positive electrode current collector using a doctor blade or a die coater such that the positive electrode active material per unit area is in the range as indicated above; and drying the resulting coating film under a high temperature atmosphere. The coating may be repeated until the desired amount of the positive electrode active material is obtained.

As other methods for preparing the positive electrode, a method of forming the positive electrode active material layer by CVD or sputtering may be used; or alternatively the positive electrode active material layer is previously formed, and then a thin film of aluminum, nickel or an alloy thereof may be formed as the positive electrode current collector on the positive electrode active material layer by deposition or sputtering.

### [Negative Electrode]

The negative electrode may have a configuration in which the negative electrode active material is adhered integrally on a negative electrode current collector using a binder for the negative electrode.

The negative electrode active material should absorb and release lithium ions during charge/discharge. For example, metal oxides, metals capable of forming lithium alloys, carbonaceous materials, silicon materials or the like may be used. These materials absorb lithium ions during charge and release lithium ions during discharge. Among others, silicon materials having high operation voltage are adventurously used herein in that a decrease in energy density is suppressed and an increase in resistance around the end of discharge is suppressed. As silicon materials, silicon or silicon oxides such as SiO or SiO₂ may be used. Silicon oxides are preferred since they are stable and have low reactivity with other substances. Also, composites of these silicon materials and carbonaceous materials are preferred. To increase conductivity, any one or two or more of nitrogen, boron or sulfur may be added in these silicon materials at 0.1-5 mass %.

Examples of carbonaceous materials for the negative electrode active material include graphite, amorphous carbon, diamond-like carbon, carbon nanotube or the like. These materials may be used alone or any combination of two or more species. Graphite of high-crystallinity is preferred since it has high electro-conductivity to maintain adhesion to a current collector made of metals such as copper and constant voltage. On the other hand, amorphous carbon has a low variation in volume during charge/discharge, so as to alleviate volume expansion across the negative electrode and suppress deterioration due to defects in grain boundaries and structures.

As metal oxides, for example, aluminum oxide, tin oxide, indium oxide, zinc oxide, lithium oxide or the like may be used. To increase conductivity, any one or two or more of N,

B or S may be added in these oxides at 0.1-5 mass %. Examples of metals include Al, Si, Pb, Sn, In, Bi, Ag, Ba, Ca, Hg, Pd, Pt, Te, Zn, La, or alloys thereof.

As for the negative electrode active material, an amount per unit area of the negative electrode is preferably 1.1-1.6 times of the positive electrode active material amount per unit area of the positive electrode. Specifically, the negative electrode active material amount per unit area of the negative electrode may be 50-130 mg/cm². If the negative electrode active material amount is in said range, the amount may be easily adjusted relative to the positive electrode active material amount, the negative electrode active material layer comprising the negative electrode active material may be easily prepared, and a cell may be easily fabricated.

The negative electrode active material may be used with an electro-conductive additive. The same electro-conductive additives and amounts as listed for the positive electrode may be used.

The negative electrode active material and the electro-conductive additive may be formed integrally as a negative electrode active material layer adhered on a negative electrode current collector using a binder for the negative electrode. The same binders as listed for the positive electrode binders, and polyimide or polyamideimide may be preferably used. A content of the negative electrode binder used may preferably be 1-30 mass % and more preferably 2-25 mass % with respect to the sum of the negative electrode active material and the negative electrode binder. If the content of the negative electrode binder is not less than 1 mass %, adhesion between active materials and between active materials and current collectors as well as cycle properties may be improved. If the content is not more than 30 mass %, the ratio of active materials and the capacity of the negative electrode may be increased.

Any current collector may be used as the negative electrode current collector as long as it has conductivity enough to allow a conductive connection with an outer terminal and supports the negative electrode active material layer comprising the negative electrode active material together with the binder. As a material for the negative electrode current collector, nickel, copper, an alloy thereof or the like may be used, and copper is more preferred.

A thickness of the negative electrode current collector is preferably a thickness having strength enough to support the negative electrode active material layer. The thickness may be the same thickness as described for the positive electrode current collector.

The negative electrode including the negative electrode active material may be prepared by providing a material for the negative electrode active material layer obtained from mixing a powder of the negative electrode active material, and as appropriate the negative electrode binder and the electro-conductivity additive in solvent such as N-methyl-2-pyrro-lidone; coating the resulting material for the negative electrode active material layer on the negative electrode current collector such as a copper foil; rolling or pressing directly without using a solvent; and drying the resulting coating film under a high temperature atmosphere to form the negative electrode active material layer. As other methods for preparing the negative electrode, the same methods as described for the preparation of the positive electrode active material layer may be used.

### [Electrolytic Solution]

The electrolytic solution is prepared by dissolving electrolyte in organic solvent and can dissolve lithium ions. The positive and negative electrodes are immersed in the electrolytic solution, so that lithium ions can be absorbed and released in the positive and negative electrodes during charge/discharge.

Preferably, the solvents suitable for the electrolytic solution have low degradation in repetitive charge/discharge and liquidity enough to immerse the positive and negative electrodes, so that cell life may be prolonged. Examples of solvents used in the electrolytic solution may include cyclic carbonates such as propylene carbonate (PC), ethylene carbonate (EC), butylene carbonate (BC) or vinylenecarbonate (VC); chain carbonates such as dimethyl carbonate (DMC), diethylcarbonate (DEC), ethylmethylcarbonate (EMC) or dipropyl carbonate (DPC); aliphatic carboxylic acid esters such as methyl formate, methyl acetate or ethyl propionate; γ-lactones such as γ-butyrolactone; chain ethers such as 1,2-ethoxyethane (DEE) or ethoxymethoxyethane (EME); cyclic ethers such as tetra-hydrofuran or 2-methyltetrahydrofuran; aprotic organic solvents such as dimethyl sulfoxide, 1,3-dioxolane, dioxolane derivatives, formamide, acetoamide, dimethyl formamide, acetonitrile, propylnitrile, nitromethane, ethylmonoglyme, phosphatetriester, trimethoxymethane, sulforane, methylsulforane, 1,3-dimethyl-2-imidazolidinone, 3-methyl-2-oxazolidinone, propylene carbonate derivatives, tetrahydrofuran derivatives, ethylether, 1,3-propanesultone, anisole, or N-methylpyrrolidone; or others. These solvents may be used alone or as a combination of two or more species.

As electrolytes contained in the electrolytic solution, lithium salts are preferably used. Examples of lithium salts may include LiPF₆, LiAsF₆, LiAlCl₄, LiClO₄, LiBF₄, LiSbF₆, LiCF₃—SO₃, LiC₄F₉CO₃, LiC(CF₃SO₂)₃, LiN(CF₃SO₂)₂, LiN(CF₃SO₂)₂, LiB₁₀Cl₁₀, lower aliphatic lithium carboxylate, chloroborane lithium, lithium tetraphenyl borate, lithium bisoxalate borate (LiBOB), LiBr, LiI, LiSCN, LiCl, imides or the like. They may be used alone or as a combination of two or more species.

The preferred electrolytic solution includes those containing LiPF₆ as the electrolyte.

Alternatively, polymer electrolyte, inorganic solid electrolyte, ionic liquid or the like may be used instead of the electrolytic solution.

A concentration of the electrolyte in the electrolytic solution is preferably within the range of 0.01 to 3 mol/L, and more preferably the range of 0.5 to 1.5 mol/L. If the concentration of the electrolyte is in said ranges, a cell having high safety, high reliability, and low environmental effect may be obtained.

### [Separator]

Any separator may be used as long as it suppresses a contact between the positive electrode and the negative electrode, allows the penetration of charge carriers, and has durability in the electrolytic solution. Specific materials suitable for the separator may include polyolefin, for example polypropylene or polyethylene based microporous membranes, celluloses, polyethylene terephthalate, polyimide, polyfluorovinylidene or the like. They may be used as a form such as porous film, fabric or nonwoven fabric.

### [Cell Outer Body]

Preferably, the outer body should have strength to stably hold the positive electrode, the negative electrode, the separator and the electrolytic solution, is electrochemically stable to these components, and has air- and water-tightness to suppress the penetration of water vapor. For example, stainless steel, nickel-plated iron, aluminum, titanium, or alloys thereof or those plating, metal laminate resins or the like may be used. As resins suitable for the metal laminate resins, polyethylene, polypropylene, terephthalate or the like may be used. They may be used as a structure of a single layer or two or more layers. For a layered laminate, laminate films of polypropylene or polyethylene coated with aluminum or silica may be used. An aluminum laminate film is preferred since volume expansion can be effectively suppressed.

### [Lithium Secondary Cell]

A form of the lithium secondary cell as indicated above may have any of cylindrical, flat winding rectangular, stacked rectangular, coin, winding laminate, flat winding laminate or stacked laminate forms.

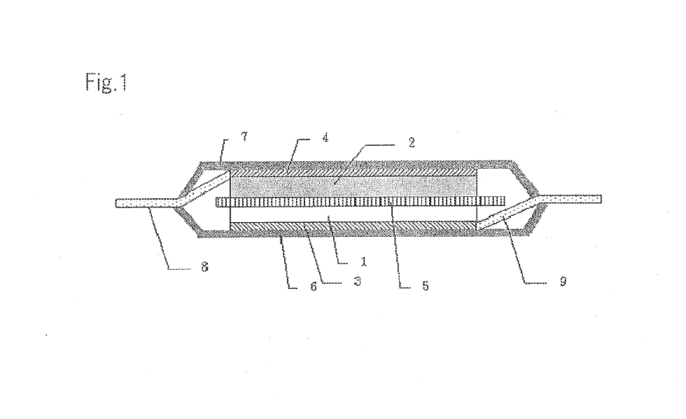

As an example of the lithium secondary cell, a stacked laminate secondary cell is shown in FIG. 1. The stacked laminate secondary cell has a structure that a negative electrode having a negative electrode active material layer 1 laminated on a negative current collector 3 and a positive electrode having a positive electrode active material layer 2 laminated on a positive electrode current collector 4 such as an aluminum foil are disposed opposite each other with an separator 5 intervened to prevent a contact between the electrodes, and these are accommodated within a laminate film outer body 6, 7. An electrolytic solution is filled inside the laminate film outer body. A negative lead tab 9 connected to the negative current collector 3 and a positive lead tab 8 connected to the positive current collector 4 are drawn outwardly from the laminate film outer body and used as electrode terminals, respectively.

### [Charge/Discharge]

The lithium secondary cell as described above is preferably charged and discharged in the range of the upper limit 4.2V of charge voltage to the lower limit 2.5V of discharge voltage. If the lower limit of discharge voltage is 2.5V, the deterioration of discharge capacity in repetitive charge/discharge may be suppressed, and a circuit may easily be designed. If the upper limit of charge voltage is 4.2V, a decrease in absolute value of discharge capacity is suppressed, and the discharge capacity of the negative electrode active material may be effectively used. The charge/discharge is preferably performed between 4.2V and 2.7V.

### [Production Method]

To produce the lithium secondary cell according to the present invention, the positive electrode having the positive electrode active material layer containing the manganese olivine compound (1) and the lithium nickel oxide (2) formed on the positive electrode current collector and the negative electrode having the negative electrode active material layer formed on the negative electrode current collector are disposed opposite each other with the separator intervened within the outer body. Then, the electrolytic solution is filled within the outer body and the outer body is sealed under vacuum.

### EXAMPLES

Now, the lithium secondary cell according to the present invention will be described in detail.
[Preparation of Positive Electrode Active Material]
[Preparation of Manganese Olivine Compound (1)]

Precursors having a desired element ratio were produced using MnSO₄.5H₂O (made by Kanto Chemical Co., Inc.), FeSO₄.7H₂O (made by Wako Pure Chemical Industries, Ltd.), LiOH.H₂O (made by Kanto Chemical Co., Inc.) and H₃PO₄ (made by Wako Pure Chemical Industries, Ltd.). Then, the precursors were sintered at 300-600° C. for 6-24 hr under N₂ atmosphere to obtain sintered bodies. The sintered bodies were ground to obtain manganese olivine compounds (1) (first active materials) C1-1-C1-10 as shown in Table 1 below. The resulting powders were confirmed as single-phased powders as measured by X-ray diffraction.

TABLE 1

| | First active | |
|---|---|---|
| | materials | Compositions |
| Mn series | C1-1 | LiMnPO₄ |
| Mn—Fe series | C1-2 | LiMn_{0.92}Fe_{0.08}PO₄ |
| | C1-3 | LiMn_{0.87}Fe_{0.13}PO₄ |
| | C1-4 | LiMn_{0.83}Fe_{0.17}PO₄ |
| | C1-5 | LiMn_{0.76}Fe_{0.24}PO₄ |
| | C1-6 | LiMn_{0.70}Fe_{0.30}PO₄ |
| Mn—Mg series | C1-7 | LiMn_{0.94}Mg_{0.06}PO₄ |
| | C1-8 | LiMn_{0.88}Mg_{0.12}PO₄ |
| | C1-9 | LiMn_{0.81}Mg_{0.19}PO₄ |
| | C1-10 | LiMn_{0.77}Mg_{0.23}PO₄ |

### [Preparation of Lithium Nickel Oxide (2)]

Precursors having a desired element ratio were produced using NiSO₄.6H₂O (made by Wako Pure Chemical Industries, Ltd.), MnSO₄.5H₂O (made by Kanto Chemical Co., Inc.), CoSO₄.7H₂O (made by Kanto Chemical Co., Inc.) and Al₂(SO₄)₃ (made by Kanto Chemical Co., Inc.). Then, the precursors were mixed with Li₂Co₃ (made by Honjo Chemical Corporation), and were sintered at 600-800° C. for 12-48 hr to obtain sintered bodies. The sintered bodies were ground to obtain lithium nickel oxides (2) (second active materials) C2-1-C2-6 as shown in Table 2 below. The resulting powders were confirmed as single-phased powders as measured by X-ray diffraction.

TABLE 2

| | Second active | |
|---|---|---|
| | materials | Compositions |
| Ni—Co—Mn series | C2-1 | LiNi_{0.8}Co_{0.15}Mn_{0.05}O₂ |
| | C2-2 | LiNi_{0.75}Co_{0.15}Mn_{0.10}O₂ |
| Ni—Co—A1 series | C2-3 | LiNi_{0.75}Co_{0.20}Al_{0.05}O₂ |
| Ni—Co—Mg series | C2-4 | LiNi_{0.75}Co_{0.20}Mg_{0.05}O₂ |
| Ni—Co—V series | C2-5 | LiNi_{0.75}Co_{0.15}V_{0.05}O₂ |
| Ni—Co—Mn—Al series | C2-6 | LiNi_{0.60}Co_{0.20}Mn_{0.10}Al_{0.1}O₂ |

### Example 1

A slurry for a positive electrode was prepared by weighing a positive electrode active material in which C1-1 and C2-1 are mixed such that the content of C2-1 is 12 mass %, a polyvinylidene fluoride binder and an acetylene black electro-conductive additive at the weight ratio of 90:5:5, and blending these components in a NMP solution. The slurry for a positive electrode was coated on an aluminum foil and dried. The coating film was pressed using a roll press to form a positive electrode active material layer having 2.2-2.7 g/cm³ of cell density. The resulting unit was cut into 80 mm×160 mm size to obtain a positive electrode.

A slurry for a negative electrode was prepared by weighing silicon oxide having the center particle size D50 of 11.5 nm as a negative electrode active material, acetylene black and fibrous graphite as an electro-conductive additive and polyimide dispersed in NMP as a binder at the weight ratio of 80:15:3:2, and blending these components. The slurry for a negative electrode was coated on a copper foil, dried and heated at 200° C. for 2 hr under nitrogen atmosphere. The resulting negative electrode active material layer has 2.2-2.7 g/cm³ of cell density. The resulting unit was cut into 80 mm×162 mm size to obtain a negative electrode.

The positive electrode of three-layered laminate and the negative electrode of fore-layered laminate were stacked with a separator intervened therebetween. The whole unit was inside a laminate outer body, sealed at three sides, and dried at 85° C. for 24 hr under reduced pressure. Then, electrolytic solution of 1M lithium phosphorus fluoride in mixed solution of ethylene carbonate and dimethyl carbonate at volume ratio of 30:70 was filled, and the laminate outer body was sealed to fabricate a layered laminate secondary cell.

### [Measurement of Capacity Maintenance]

The resulting layered laminate secondary cell was charged by the constant current of 20 mA to the upper voltage 4.2V, and then the cell was charged by constant voltage in 5 hr. Subsequently, the cell was discharged by the constant current of 20 mA to the lower voltage 2.7V. Afterward, the capacity of the cell was measured. This cycle of charge/discharge was repeated 150 times, and the capacity was measured. The ratio of discharge capacity after 150 cycles to initial discharge capacity, i.e., 150 cycle capacity retention rate was calculated. The result is shown in Table 3.

### Examples 2-10

Layered laminate secondary cells were fabricated by the same method as in Example 1 except for using manganese olivine compounds (1) (first active materials) as shown in Table 3. The charge/discharge cycle was performed and the capacity retention rate was calculated using the same method as in Example 1. The results are shown in Table 3.

### Comparative Eexamples 1-10

Layered laminate secondary cells were fabricated by the same method as in Examples 1-10 except for using no lithium nickel oxide (2) (second active material). The charge /discharge cycle was performed and the capacity retention rate was calculated using the same method as in Examples 1-10. The results are shown in Table 3.

TABLE 3

| | | | Capacity |
|---|---|---|---|
| | | | retention rate |
| | First active | Second active | (%) after 150 |
| | materials | materials | cycles |
| Example 1 | C1-1 | C2-1 | 33 |
| Example 2 | C1-2 | C2-1 | 40 |
| Example 3 | C1-3 | C2-1 | 65 |
| Example 4 | C1-4 | C2-1 | 77 |
| Example 5 | C1-5 | C2-1 | 81 |
| Example 6 | C1-6 | C2-1 | 80 |
| Example 7 | C1-7 | C2-1 | 45 |
| Example 8 | C1-8 | C2-1 | 64 |
| Example 9 | C1-9 | C2-1 | 75 |
| Example 10 | C1-10 | C2-1 | 79 |
| Com. Ex. 1 | C1-1 | None | 14 |
| Com. Ex. 2 | C1-2 | None | 23 |
| Com. Ex. 3 | C1-3 | None | 45 |
| Com. Ex. 4 | C1-4 | None | 56 |
| Com. Ex. 5 | C1-5 | None | 63 |
| Com. Ex. 6 | C1-6 | None | 61 |
| Com. Ex. 7 | C1-7 | None | 36 |
| Com. Ex. 8 | C1-8 | None | 47 |
| Com. Ex. 9 | C1-9 | None | 51 |
| Com. Ex. 10 | C1-10 | None | 63 |

From these results, in cases of cells using the manganese olivine compound (1) together with the lithium nickel oxide (2), it is demonstrated that a decrease in capacity during charge/discharge cycles is suppressed and superior cycle properties are obtained.

### Examples 11-15

Layered laminate secondary cells were fabricated by the same method as in Example 5 except for using lithium nickel oxides (2) (second active materials) as shown in Table 4. The charge/discharge cycle was performed and the capacity retention rate was calculated using the same method as in Example 5. The results are shown in Table 4.

TABLE 4

| | First active | Second active | Capacity retention rate |
|---|---|---|---|
| | materials | materials | (%) after 150 cycles |
| Example 11 | C1-5 | C2-2 | 80 |
| Example 12 | C1-5 | C2-3 | 85 |
| Example 13 | C1-5 | C2-4 | 81 |
| Example 14 | C1-5 | C2-5 | 81 |
| Example 15 | C1-5 | C2-6 | 87 |
| Example 5 | C1-5 | C2-1 | 81 |
| Com. Ex. 5 | C1-5 | None | 63 |

From these results, in cases of cells using the manganese olivine compound (1) together with the lithium nickel oxide (2), it is demonstrated that a decrease in capacity during charge/discharge cycles is suppressed and superior cycle properties are obtained.

### Examples 16-23, Comparative Examples 11-15

A powder of the manganese olivine compound (1) C1-5 and a powder of the lithium nickel oxide (2) C2-3 were mixed such that the ratios of manganese olivine compounds (1) are obtained as shown in Table 5. The mixed power of 5 g and an electrolytic solution of 50 ml are placed and sealed in a container made of polytetrafluoroethylene. The container was kept at 80° C. in a thermostat for 10 days. Afterward, a concentration of manganese in the electrolytic solution was measured by an inductively coupled plasma spectrometer (ICP). The results are shown in Table 5.

TABLE 5

| | | Amount of Mn |
|---|---|---|
| | Content of C1-5 | leaked |
| | (mass %) | (ppm) |
| Example 16 | 95 | 315 |
| Example 17 | 90 | 290 |
| Example 18 | 88 | 274 |
| Example 19 | 85 | 182 |
| Example 20 | 80 | 168 |
| Example 21 | 75 | 162 |
| Example 22 | 67 | 157 |
| Example 23 | 60 | 151 |
| Com. Ex. 11 | 99 | 799 |
| Com. Ex. 12 | 50 | 144 |
| Com. Ex. 13 | 34 | 138 |
| Com. Ex. 14 | 0 | 865 |
| Com. Ex. 15 | 0 | 840 |

From these results, it is demonstrated that the elusion of Mn into the electrolytic solution is suppressed when the manganese olivine compound (1) is present in the range of 50 to 95 mass %.

### Examples 24-31, Comparative Examples 16-20

Output characteristics in an area in which the remaining capacity of cell is small was evaluated using the ratio of discharge capacity in 1 C high current discharge to discharge capacity in 0.01 C low current discharge after SOC of charge capacity is 30%.

Lithium secondary cells were made by the same method as in Example 1 using positive electrode active materials containing the manganese olivine compound (1) C1-5 and the lithium nickel oxide (2) C2-3 respectively at the same ratios as listed in Examples 16-23 and Comparative examples 11-15. The cells were charged by the constant current of 0.2 C to 4.2V at 20° C., and then the cells were charged by the constant current and voltage for 5 hr. Subsequently, the cells were discharged by 0.05 C until charge capacities SOCs were 30%, and then the cells were discharged by the constant current of 1 C to 2.7V. Afterward, discharge capacity (a) was measured. Alternatively the cells were charged and discharged with the same way until remaining charge capacities SOCs of cells were 30%, and then the cells were discharged by the constant current of 0.01 C to 2.7V. Then discharge capacity (b) was measured. The ratio (a/b) of the discharge capacity (a) to discharge capacity (b) are calculated.

The SOC of charge capacity was calculated in the condition that charge capacity when a positive electrode in which the content of manganese olivine compound (1) is 88 mass % with respect to the sum weight of the manganese olivine compound (1) and the lithium nickel oxide (2) exhibits the maximum release of lithium is SOC 100%, and discharge capacity when the positive electrode exhibits the maximum absorption of lithium is SOC 0%. The results are shown in Table 6.

TABLE 6

| | Content of | |
|---|---|---|
| | C1-5 | a/b |
| | (mass %) | (%) |
| Example 24 | 95 | 63 |
| Example 25 | 90 | 62 |
| Example 26 | 88 | 65 |
| Example 27 | 85 | 64 |
| Example 28 | 80 | 62 |
| Example 29 | 75 | 60 |
| Example 30 | 67 | 57 |
| Example 31 | 60 | 52 |
| Com. Ex. 16 | 99 | 24 |
| Com. Ex. 17 | 50 | 33 |
| Com. Ex. 18 | 34 | 31 |
| Com. Ex. 19 | 0 | 21 |
| Com. Ex. 20 | 0 | 23 |

From these results, it is demonstrated that the output characteristics in low SOC area are good when the content of manganese olivine compound (1) is 60-95 mass %. When the content of manganese olivine compound (1) was 50 mass % and 66 mass %, elusion into the electrolyte was suppressed (Comparative examples 12 and 13), however the output characteristics were deteriorated in the low SOC area. It is considered that discharge voltage is lowered and cut-off voltage is readily reached due to the high content of lithium nickel oxide.

### Examples 32-47

Lithium secondary cells were made by the same method as in Example 24 except for using the amounts as shown in Table 7 as coating amounts of the manganese olivine compounds (1) (first active materials) and the lithium nickel oxides (2) (second active materials) used for the positive electrode active material, setting the content of the lithium nickel oxides (2) in the positive electrode active material to 12 mass %, and setting the negative electrode active material amount per unit area of the negative electrode to 1.1-1.6 times of the positive electrode active material amount per unit area of the positive electrode. The output characteristics in low SOC area were evaluated. The results are shown in Table 7.

TABLE 7

| | | | Weight of | |
|---|---|---|---|---|
| | | | positive | |
| | | | electrode | |
| | First active | Second active | active material | a/b |
| | materials | materials | (mg/cm²) | (%) |
| Example 32 | C1-5 | C2-3 | 45 | 64 |
| Example 33 | C1-5 | C2-3 | 51 | 65 |
| Example 34 | C1-5 | C2-3 | 58 | 67 |
| Example 35 | C1-5 | C2-3 | 62 | 67 |
| Example 36 | C1-5 | C2-3 | 68 | 66 |
| Example 37 | C1-5 | C2-3 | 75 | 67 |
| Example 38 | C1-5 | C2-3 | 80 | 65 |
| Example 39 | C1-5 | C2-2 | 51 | 65 |
| Example 40 | C1-5 | C2-2 | 80 | 64 |
| Example 41 | C1-9 | C2-3 | 46 | 63 |
| Example 42 | C1-9 | C2-2 | 80 | 65 |
| Example 43 | C1-5 | C2-3 | 99 | 44 |
| Example 44 | C1-5 | C2-3 | 101 | 41 |
| Example 45 | C1-5 | C2-2 | 105 | 37 |
| Example 46 | C1-9 | C2-3 | 97 | 46 |
| Example 47 | C1-9 | C2-2 | 112 | 35 |

It is demonstrated that when the positive electrode active material amount per unit area of the positive electrode is 45-80 mg/cm², the output characteristics in low SOC area are good, however the output characteristics in low SOC area are lowered when departing from said range. It is considered that the positive electrode is thicker as the positive electrode active material amount is increased, and hence the negative electrode is thicker, resulting in a resistance increase in thickness direction and uneven contact between the electrolytic solution and active materials.

This application incorporates the full disclosure of JP Patent Application No. 2011-101509 filed Apr. 28, 2011 herein by reference.

The present invention is applicable to all of industrial fields that require power supply and industrial fields that relate to transmission, storage and supply of electrical energy. Specifically, the present invention is applicable to power supply for mobile devices such as mobile phone, notebook computer or the like.

1. A lithium secondary cell in which a positive electrode includes a positive electrode active material comprising an olivine compound represented by formula (1):
LiMn₁₋ₐXₐPO₄ (1)
(where X represents Mg and/or Fe, and a represents a value that satisfies 0≦a≦0.3) and a lithium nickel oxide represented by formula (2):
LiNi_{1-b}Z_{b}O₂ (2)
(where Z represents one or more selected from Co, Mn, Al, Mg, and V; and b represents a value that satisfies 0≦b≦0.4), and the positive electrode active material contains 60 to 95 mass % of the olivine compound represented by the formula (1).

2. A lithium secondary cell of claim 1 wherein the positive electrode active material contains 5 to 40 mass % of the lithium nickel oxide represented by the formula (2).

3. A lithium secondary cell of claim 1 wherein the positive electrode active material amount per unit area of the positive electrode is 45-80 mg/cm2.

4. A lithium secondary cell of claim 1 wherein a negative electrode includes a negative electrode active material containing silicon-based materials.

5. A lithium secondary cell of claim 1 wherein the negative electrode active material amount per unit area of the negative electrode is 1.1-1.6 times of the positive electrode active material amount per unit area of the positive electrode.

6. A lithium secondary cell of claim 1 wherein the upper limit of charge voltage is 4.2V and the lower limit of discharge voltage is 2.5V.

7. A lithium secondary cell of claim 1 wherein the lithium nickel oxide represented by the formula (2) comprises Co atom.

8. A lithium secondary cell of claim 1 wherein the lithium nickel oxide represented by the formula (2) is LiNi_{0.6}Co_{0.2}Mn_{0.1}Al_{0.1}O₂.

9. A lithium secondary cell of claim 1 wherein the olivine compound represented by the formula (1) comprises Fe atom.
